(19) United States
(12) Patent Application Publication
(10) Pub. No.: US 2006/0054084 A1
(43) Pub. Date: Mar. 16, 2006

(54) Painting device of a crash pad

(75) Inventor: Sung-Won Hwang, Yongin-si (KR)

Correspondence Address: GREENBLUM & BERNSTEIN, P.L.C., 1950 ROLAND CLARKE PLACE, RESTON, VA, 20191, US

(73) Assignee: Hyundai Mobis Co., Ltd., Seoul (KR)

(21) Appl. No.: 11/165,220

(22) Filed: Jun. 24, 2005

(30) Foreign Application Priority Data
Sep. 15, 2004 (KR) 2004-73952

(51) Int. Cl. B05C 11/11

(52) U.S. Cl. 118/504; 15/210.1

(57) ABSTRACT

A painting device of a crash pad includes a painting jig inserted into or separated from a painting groove formed in a boundary between two tones painted on the crash pad when the crash pad is painted in two tones, so as to divide the crash pad into portions to be painted in different tones without using any adhesive material, thereby rapidly performing a painting operation and having a clean surface at the boundary.

### RELATED APPLICATIONS

The present disclosure relates to subject matter contained in Korean Application No. 10-2004-73952, filed on Sep. 15, 2004, which is herein expressly incorporated by reference its entirety.

### BACKGROUND OF THE INVENTION

1. Field of the Invention

The present invention relates to a painting device of a crash pad, which comprises a painting jig inserted into or separated from a painting groove formed in the boundary between two tones painted on the crash pad when the crash pad is painted with a color in two tones, so as to divide the crash pad into portions to be painted in different tones without using any adhesive material, thereby rapidly performing the painting operation and having a clean surface at the boundary.

2. Description of the Related Art

Generally, a crash pad is installed in front of the driver's seat and the passenger seat in an automobile, and has a shape for supplying a space for installing various devices in front of the driver's and passenger seat in the automobile.

That is, various instrument panels are installed in front of the driver's seat, a glove box is installed in front of the passenger seat, and an audio and air conditioning device are installed in front of the area between the driver's seat and the passenger seat. Further, air vents for discharging air therethrough are installed in front of both driver and passenger seat. The crash pad has a space for collecting the above devices, and the external surface of the crash pad is treated by a material having a soft texture.

Recently, crash pad has been painted with two tones, thereby improving its aesthetic appearance.

FIG. 1 is a perspective view of a conventional crash pad to be painted in an automobile.

As shown in FIG. 1, a painting line 12 for painting the conventional crash pad 11 with two tones is prepared on the crash pad 11. A lower portion of the crash pad 11 under the painting line 12 is masked using a tape or a protection vinyl, and an upper portion of the crash pad 11 on the painting line 12 is painted. Then, after the painting of the upper portion of the crash pad 11 is completed, the tape or the protective vinyl is removed from the lower portion of the crash pad 11.

In the same manner, in order to paint the lower portion of the crash pad 11, which is not painted, the upper portion of the crash pad 11 on the paining line 12 is masked using the tape or the protective vinyl, and the lower portion of the crash pad 11 is painted. Then, after the painting of the lower portion of the crash pad 11 is completed, the tape or the protective vinyl is removed from the upper portion of the crash pad 11.

In the above masking step, the portion of the crash pad 11, which is required be left unpainted, is covered with a general protective cover 13 along the painting line 12, and the protective cover 13 is firmly attached to the portion of the crash pad 11 along the protecting line 12 by a tape having a high adhesiveness.

However, in case the portion of the crash pad 11 is masked using an adhesive material along the painting line 12, when the adhesive material is detached from the portion of the crash pad 11 after painting, a pigment painted onto the other portion of the crash pad 11 frequently becomes detached.

Thereby, a boundary portion between the different tones of the crash pad 11 is not clean, but the rate of failure of painting the crash pad 11 is increased

### SUMMARY OF THE INVENTION

Therefore, the present invention has been made in view of the above problems, and it is an object of the present invention to provide a painting device of a crash pad, which comprises a jig mounted on a groove formed in the crash pad, thereby facilitating two-tone painting of the crash pod.

In accordance with the present invention, the above and other objects can be accomplished by the provision of a painting device of a crash pad, comprising a painting jig mounted on a painting groove formed on a painting line of the crash pad so that the crash pad is painted with two tones using the painting line as a boundary.

Since the non-adhesive painting jig is mounted on the painting groove formed on the painting line of the crash pad, which needs to be painted in two tones, even when the painting jig is separated from the painting groove after the painting is completed, the crash pad keeps a clean surface at boundary between portions painted in different tones.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a conventional crash pad to be painted in an automobile;

FIG. 2 is a perspective view of a crash pad in an automobile in accordance with the present invention;

FIG. 3 is a longitudinal sectional view of the crash pad, taken along the line A-A of FIG. 2, in a state in which a painting jig of the present invention is installed on the crash pad, and

FIG. 4 is a longitudinal sectional view of the crash pad, in a state in which the painting jig of the present invention is automatically operated by an operating means.

### DESCRIPTION OF THE PREFERRED EMBODIMENTS

Now, a preferred embodiment of the present invention will be described in detail with reference to the annexed drawings.

The preferred embodiment does not limit the claims of the present invention, but may be disclosed for illustrative purposes. In the following description of the present invention, elements having known functions and configurations incorporated herein will be denoted by the same reference numerals or terms even though they are depicted in different drawings.

Further, those skilled in the art will appreciate that various modifications, additions, and substitutions to the specific elements are possible, without departing from the scope and spirit of the invention as disclosed in the accompanying claims.

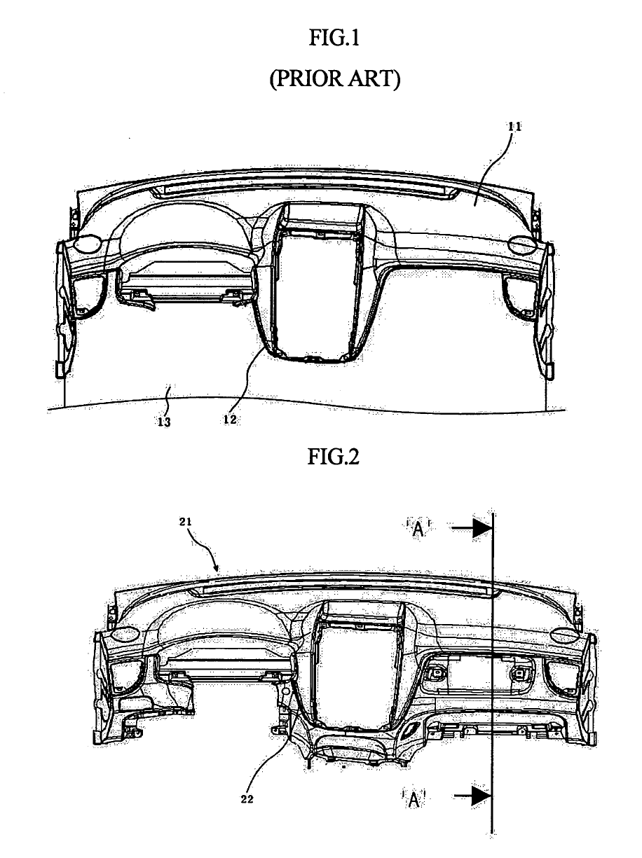

FIG. 1 is a perspective view of a conventional crash pad to be painted in an automobile.

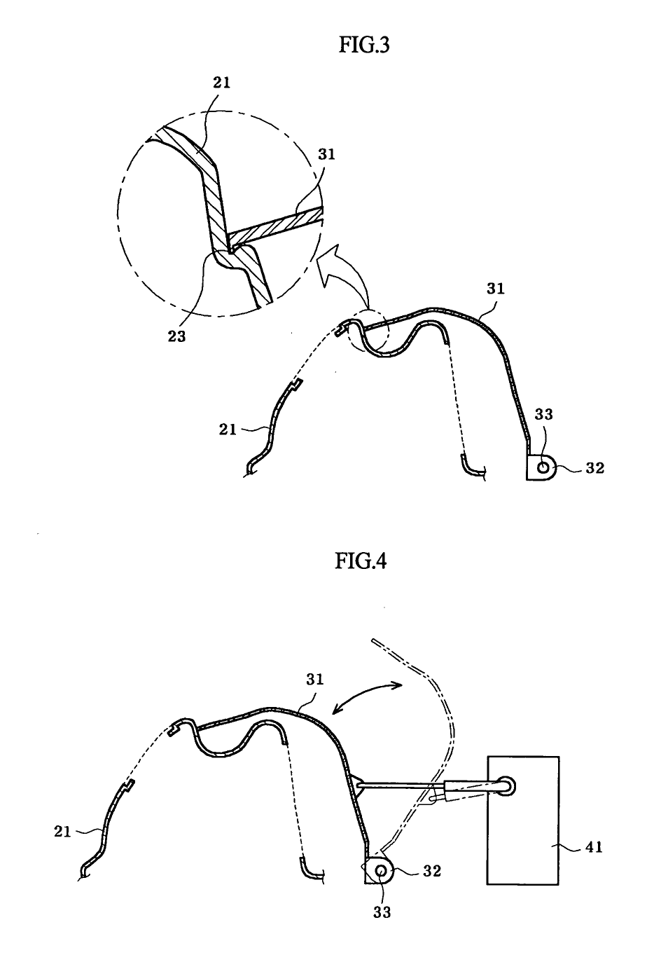

FIG. 2 is a perspective view of a crash pad in an automobile in accordance with the present invention, FIG. 3 is a longitudinal sectional view of the crash pad, taken along the line A-A of FIG. 2, in a state in which a painting jig of the present invention is installed on the crash pad, and FIG. 4 is a longitudinal sectional view of the crash pad, in a state in which the painting jig of the present invention is automatically operated by operating means.

As shown in FIGS. 2 to 4, an imaginary painting line 22 for painting a crash pad 21 in two tones is prepared at a boundary between the two tones, and a painting groove 23 is formed in the crash pad 21 along the painting line 22.

That is, as shown in FIG. 3, the painting groove 23 is formed in the crash pad 21, and a painting jig 31, which is inserted into or separated from the painting groove 23, is prepared.

Preferably, the painting groove 23 has a fine size so as to prevent paint from undesirably flowing into the painting groove 23, and the tip of the painting jig 31 has a sharpened cross-section so that the painting jig 31 is easily inserted into the painting groove 23.

Normally, the painting jig 31 is stored as a separate article. When the crash pad 21 is painted, the painting jig 31 is inserted into the painting grove 23 by hand, and is then fixed.

One end of the painting jig 31 is connected to a fixture 32 by a hinge 33 and rotated so that the painting jig 31 is inserted into or separated from the painting groove 23. In this case, the end of the painting jig 31 connected to the hinge 33 is tightened by a bolt, thereby being fixed to the fixture 32.

The painting jig 31 is provided with an operating means 41, thereby being automatically inserted into or separated from the painting groove 23.

Here, preferably, a product, such as a hydraulic cylinder, the length of which is varied, is used as the operating means 41.

Hereinafter, the operation and effects of the above-described painting device of the crash pad of the present invention will be described.

In order to paint the crash pad 21 in two tones in a manufacturing process, the tip of the painting jig 31 is inserted into the painting groove 23 formed in the crash pad 21 so that a portion of the crash pad 21 to be left unpainted is protected, and then a painting operation is performed. Thereafter, the painting jig 31 is separated from the painting groove 23, thereby completing the painting operation.

Here, the painting jig 31 is a product separated from the crash pad 21. The painting jig 31 is inserted into the painting groove 23 by a worker, and is then fixed to the painting groove 32 using a separate fixing member.

On the other hand, the paining jig 31 is fixed by tightening a hinge shaft using a separate bolt under the condition that one end of the painting jig 31 is connected to the fixture 32 formed at an area close to a production line by a hinge 33 and the other end of the painting jig 31 is inserted into the painting groove 23.

The above painting operation is performed by the worker. However, as shown in FIG. 4, the painting operation may be automatized by connecting the operating means 41 to the painting jig 31 and then inserting the painting jig 31 into the painting grove 23.

As apparent from the above description, the present invention provides a painting device of a crash pad, which comprises a painting jig inserted into a painting groove formed in the crash pad to divide the crash pad into a portion to be painted and a portion not to be painted, and does not require any adhesive material, thereby rapidly performing a painting operation and aesthetically treating a boundary portion between the portions of the crash pad.

Further, the painting jig of the painting device is automatically inserted into or separated from the painting groove by connecting an operating means, the length of which is varied, to the painting jig, thereby automatically performing the painting operation.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A painting device of a crash pad, comprising a painting jig mounted on a painting groove formed on a painting line of the crash pad so that the crash pad is painted with two tones using the painting line as a boundary.

2. The painting device as set forth in claim 1, wherein the painting jig is connected to a fixture by a hinge and is rotated so as to be inserted into or separated from the painting groove of the crash pad.

3. The painting device as set forth in claim 1, wherein the painting jig is provided with an operating device, the length of which is varied, so that the painting jig is automatically inserted into or separated from the painting groove.

4. The painting device as set forth in claim 2, wherein the painting jig is provided with an operating device, the length of which is varied, so that the painting jig is automatically inserted into or separated from the painting groove.
